(19) United States
(12) Patent Application Publication
(10) Pub. No.: US 2021/0039482 A1
(43) Pub. Date: Feb. 11, 2021

(54) Foldable Sunshade

(71) Applicant: Pengbo Liu, Huizhou City (CN)

(72) Inventor: Pengbo Liu, Huizhou City (CN)

(21) Appl. No.: 16/534,252

(22) Filed: Aug. 7, 2019

(51) Int. Cl. B60J 1/20

(52) U.S. Cl. CPC B60J 1/2091

(57) ABSTRACT

A foldable sunshade including a shading board body and a fixed part, two or more than two vertical folding lines which are distributed along the transverse direction of the shading board body and run through the vertical direction of the shading board body are arranged on the shading board body, and the shading board body is divided into a plurality of folding units by every two adjacent vertical folding lines and two transverse sides of the shading board body, or one vertical folding line, one vertical side of the shading board body and two transverse sides of the shading board body; two transverse folding lines running through the transverse direction of each folding unit are further arranged at the center of each folding unit, and the two transverse folding lines are symmetrically distributed by taking the transverse center line of the shading board body as a symmetry axis.

### BACKGROUND OF THE INVENTION

### Field of the Invention

This disclosure pertains to the technical field of shading, and particularly pertains to a foldable sunshade.

### Description of the Related Art

Shading boards are usually used at the positions of a front windshield and a rear windshield of an automobile, when the automobile is parked on the ground, if the intensity of sunshine is high, the temperature inside the automobile can be rapidly increased, and the aging of an instrument board, an instrument desk and automobile seats can also be quickened. Sunlight is extremely difficult to enter the automobile after the shading boards are used, preferable cooling and sun screening effects are achieved, and simultaneously, the instrument board and leather seats further can be protected.

This applicant finds at least the following technical problems existing in the prior art: the shading boards are usually folded irregularly or directly put inside a trunk when being folded, so that the space is occupied, folding marks are out of order due to disordered folding of the shading boards, and the service life of the folding board is shortened.

### SUMMARY OF THE INVENTION

This disclosure aims to provide a foldable sunshade so as to solve the technical problem that a shading board cannot be folded quickly and regularly in the prior art. Various technical effects generated by a preferred technical scheme in various technical schemes provided by this disclosure are explained in detail as follow:

In order to achieve the above purpose, this disclosure provides the following technical scheme:

The foldable sunshade provided by this disclosure comprises a shading board body and a fixed part, two or more than two vertical folding lines which are distributed along the transverse direction of the shading board body and run through the vertical direction of the shading board body are arranged on the shading board body, and the shading board body is divided into a plurality of folding units by every two adjacent vertical folding lines and two transverse sides of the shading board body, or one vertical folding line, one vertical side of the shading board body and two transverse sides of the shading board body; transverse folding lines running through the transverse direction of each folding unit are further arranged at the center of each folding unit, the quantity of the transverse folding lines in each folding unit is two, and the two transverse folding lines in each folding unit are symmetrically distributed by taking the transverse center line of the shading board body as a symmetry axis; the shading board can be folded along the vertical folding lines and the transverse folding lines, and the folded shading board is fixed by using the fixed part.

Further, the lengths of segments, intercepted by every two adjacent vertical folding lines, of straight lines parallel to the transverse center line of the shading board body are equal.

Further, the folding directions of every two adjacent vertical folding lines are opposite.

Further, along the direction from the first end of the transverse direction of the shading board body to the second end of the transverse direction of the shading board body, in every two adjacent folding units, the distance between two transverse folding lines of the folding unit closer to the second end is greater than that between two transverse folding lines of the folding unit closer to the first end.

Further, the distance between two transverse folding lines of the folding unit mostly close to the first end is greater than the thickness of the shading board body.

Further, along the direction from the first end to the second end, the distance between two transverse folding lines of the folding unit is increased in an arithmetic progression manner.

Further, the tolerance of the arithmetic progression is the thickness of the shading board body.

Further, the fixed part is a fastener, the fastener is detachably connected with the shading board body, the fastener comprises a fastener body, an inserter connected with the upper edge of the fastener body and a snap closure connected with the upper surface of the fastener body, inserter holes and a snap closure hole corresponding to the inserter and the snap closure are formed in the shading board body, and the fastener is connected with the shading board body through the inserter holes and the snap closure hole.

Further, the fastener is mounted at one end of the folding unit close to the second end, and the fastener is positioned on the outer surface of the folding body after the shading board body is completely folded.

Further, the shading board body is in the shape of a rounded rectangle.

This disclosure has the beneficial effects that the vertical folding lines and the transverse folding lines are arranged on the shading board body, and the shading board body is folded along the vertical folding lines and the transverse folding lines in sequence, so that folding marks are avoided from being distributed on the shading board body due to random folding, and the occupied storage space is reduced.

### BRIEF DESCRIPTION OF THE DRAWINGS

In order to illustrate the technical scheme in the embodiment of this disclosure or in the prior art more clearly, the accompanying diagrams needing to be used in the embodiment or in the description in the prior art are simply described. Apparently, the embodiments in the following description are merely a part rather than all of the embodiments of this disclosure. For any person skilled in the art, under the premise of without contributing creative labor, other accompanying diagrams further can be obtained according to these accompanying diagrams.

FIG. 1 is a schematic diagram of a foldable sunshade in this disclosure;

FIG. 2 is a schematic diagram of the folding process that a shading board body of the foldable sunshade in this disclosure along the vertical folding lines;

FIG. 3 and FIG. 4 are schematic diagrams of the folding process along the transverse folding lines after FIG. 2 is completed;

FIG. 5 is a schematic diagram of a complete folding state of the foldable sunshade in this disclosure;

In the figures, 1, shading board body; 11, vertical folding line; 12, transverse folding line; 13, inserter hole; 14, snap closure hole; 2, fastener; 21, fastener body; 22, inserter; and 22, snap closure.

### DETAILED DESCRIPTION OF THE SEVERAL EMBODIMENTS

In order to make the purpose, technical scheme and advantages of this disclosure more clear, the technical scheme of this disclosure is described in detail as follows: Apparently, the embodiments in the following description are merely a part rather than all of the embodiments of this disclosure. Based on the embodiment in this disclosure, all other embodiments obtained by the ordinary technical staff in the art under the premise of without contributing creative labor belong to the scope protected by this disclosure.

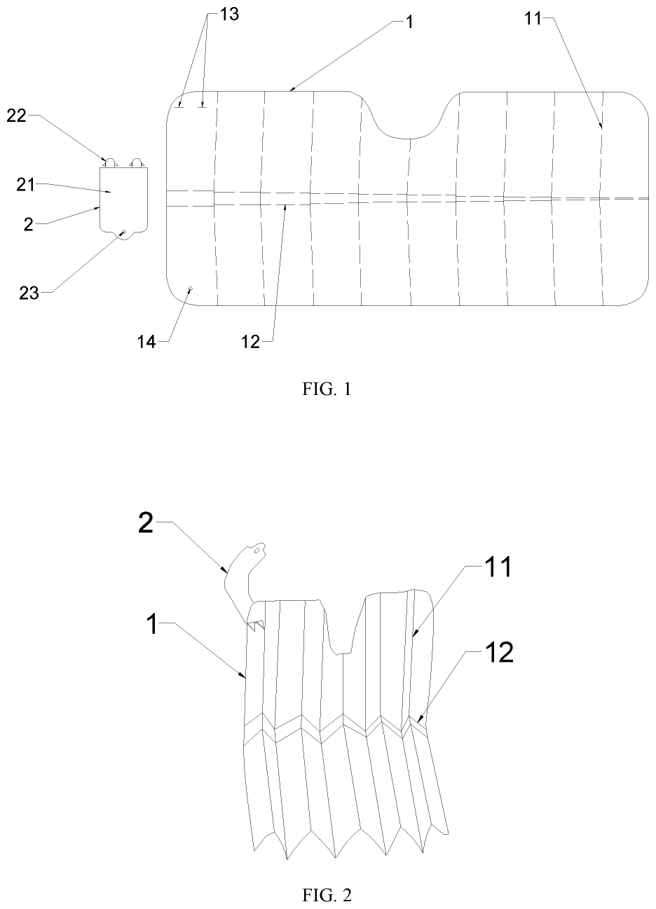

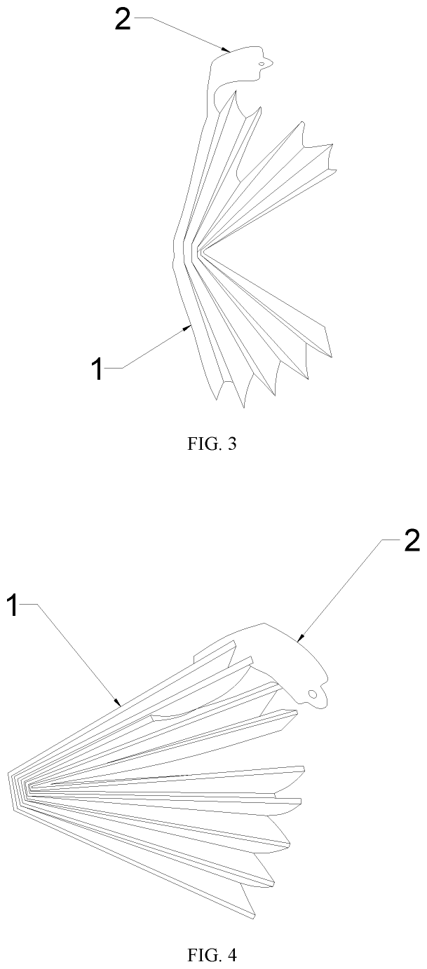

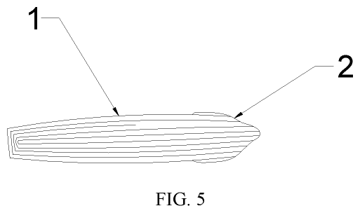

As shown in FIG. 1 to FIG. 5, the foldable sunshade provided by this disclosure comprises a shading board body 1 and a fixed part, two or more than two vertical folding lines 11 which are distributed along the transverse direction of the shading board body 1 and run through the vertical direction of the shading board body 1 are arranged on the shading board body 1, and the shading board body 1 is divided into a plurality of folding units by every two adjacent vertical folding lines 11 and two transverse sides of the shading board body 1, or one vertical folding line 11, one vertical side of the shading board body 1 and two transverse sides of the shading board body 1; transverse folding lines running through the transverse direction of each folding unit are further arranged at the center of each folding unit, the quantity of the transverse folding lines in each folding unit is two, and the two transverse folding lines in each folding unit are symmetrically distributed by taking the transverse center line of the shading board body 1 as a symmetry axis; the shading board can be folded along the vertical folding lines 11 and the transverse folding lines 12, and the folded shading board 1 is fixed by using the fixed part. The vertical folding lines 11 and the transverse folding lines 12 are arranged on the shading board body 1, and the shading board body 1 is folded along the vertical folding lines 11 and the transverse folding lines 12 in sequence, so that folding marks are avoided from being distributed on the shading board body 1 due to random folding, the shading board body 1 can also be folded quickly and regularly, and the occupied storage space is reduced. The vertical folding lines 11 and the transverse folding lines 12 can be arranged or pressed in a dotting manner.

As an optional mode of execution, the lengths of segments, intercepted by every two adjacent vertical folding lines 11, of straight lines parallel to the transverse center line of the shading board body 1 are equal. Through the design, after the shading board body 1 is completely folded along the vertical folding lines 11, all the folding units are overlapped together in the width direction, so that the completely folded shading board body 1 is regular and attractive in appearance.

As an optional mode of execution, the folding directions of every two adjacent vertical folding lines 11 are opposite. If the folding directions of every two adjacent vertical folding lines 11 are the same, the widths of the folding units located on the outer layers need to be wider and wider to guarantee that the folded shading board body 1 is regular and smooth, thus the width of each folding unit needs to be calculated in addition, but when the folding directions of every two adjacent vertical folding lines 11 are set to be opposite, the distances between every two adjacent vertical folding lines 11 can be set to be equal, and the operation is simple and easy.

As an optional mode of execution, along the direction from the first end of the transverse direction of the shading board body 1 to the second end of the transverse direction of the shading board body 1, in every two adjacent folding units, the distance between two transverse folding lines 12 of the folding unit closer to the second end is greater than that between two transverse folding lines 12 of the folding unit closer to the first end. When the shading board body 1 is folded completely, the folding units mostly close to the first end is located at the innermost position, thus the distance between the two transverse folding lines 12 in the folding unit mostly close to the first end is set to be minimum, however, the distance between the two transverse folding lines 12 inside the folding unit mostly close to the second end is larger, so that in order to take the thickness of the shading board body 1 after multilayer folding into account, the folding unit mostly close to the second end is located at the outermost position when the shading board body 1 is completely folded, and the distance between the two transverse folding lines 12 inside the folding unit is the maximum.

As an optional mode of execution, the distance between the two transverse folding lines 12 of the folding unit mostly close to the first end is equal to the thickness of the shading board body 1. When the shading board body 1 is folded completely, the folding unit mostly close to the first end is located at the innermost position, thus the distance between the two transverse folding lines 12 of the folding unit mostly close to the first end is the minimum, the folded shading board body 1 can be compressed and deformed appropriately, and in order to accommodate deformation generated by two shading board bodies 1 after folding, the distance between the two transverse folding lines 12 is set to be the thickness of the shading board body 1.

As an optional mode of execution, along the direction from the first end to the second end, the distance between two transverse folding lines 12 of the folding unit is increased in an arithmetic progression manner. Along the direction from the first end to the second end, the thickness of two shading board bodies 1 can be increased when one transversely folded folding unit is added, thus the distance between the two transverse folding lines 12 of the folding unit is increased by a certain interval when one folding unit is added so that the thickness of the added two shading board bodies 1 is accommodated, so that the distance between two transverse folding lines 12 of the folding unit is increased in the arithmetic progression manner along the direction from the first end to the second end.

As an optional mode of execution, the tolerance of the arithmetic progression is the thickness of the shading board body 1. The thickness of two shading board bodies 1 is increased when one transversely folded folding unit is added, in consideration of that the material of the shading board body 1 can be partially compressed, thus, the thickness of one shading board body 1 is increased at the interval between two transverse folding lines 12 of the folding unit when one folding unit is added.

As an optional mode of execution, the fixed part is a fastener 2, the fastener 2 is detachably connected with the shading board body 1, the fastener 2 comprises a fastener 2 body, inserters 22 connected with the upper edge of the fastener body 21 and a snap closure 23 connected with the upper surface of the fastener body 21, inserter holes 13 and a snap closure 23 hole 14 corresponding to the inserters 22 and the snap closure 23 are formed in the shading board body 1, and the fastener 2 is connected with the shading board body 1 through the inserter holes 13 and the snap closure 23 hole 14. The fixed part can be a rubber band, an elastic cord or a magic tape, in the embodiment, the detachable fastener 21 is used as the fixed part, so that the fastener 2 can be detached when the foldable sunshade is used, the placement of the shading board body 1 on the windshield of an automobile is not influenced, after the shading board is used completely, the shading board body 1 needs to be folded and stored, and the fastener 2 is connected with the shading board body 1 again for use. After the inserters 22 connected to the upper edge of the fastener body 21 are inserted into the inserter holes 13 in the shading board body 1, protrusions on the inserters 22 can prevent the inserters 22 from being taken off from the inserter holes 13, so that the connection between the fastener 2 and the shading board body is firmer.

As an optional mode of execution, the fastener 2 is mounted at one end of the folding unit close to the second end, and the fastener 2 is located on the outer surface of the folding body after the shading board body 1 is completely folded. The fastener 2 is mounted at one end of the folding unit of which the distance between two transverse folding lines 2 is the maximum, and the fastener 2 is located on the outer surface of the folding body, so that, after the shading board body 1 is completely folded, the fastener 2 can be buckled with the folding body of the shading board body 1, and the folding body of the shading board body 1 is unlikely to scatter.

As shown in FIG. 2 to FIG. 5, the folding method of the shading board body 1 is as follows: the shading board body 1 is folded along the vertical folding lines 11, the folding directions of every two adjacent vertical folding lines 11 are opposite, after folding is completed, the shading board body is folded according to the transverse folding lines, the folding unit of which the distance between two transverse folding lines 12 is the minimum is located at the innermost position, the folding unit of which the distance between two transverse folding lines 12 is the maximum is located at the outermost position, then the inserters 22 of the fastener 2 are mounted, right now, the fastener 2 is located on the outer surface of the folded shading board body 1, then the snap closure 23 is pressed into the snap closure 23 hole 14, and the folded shading board body 1 is completely fixed and stored.

As an optional mode of execution, the shading board body 1 is in the shape of a rounded rectangle. The shading board body 1 can be preferably adhered to the front windshield and the rear windshield of the automobile through the appearance of the rounded rectangle.

The foregoing descriptions are merely specific embodiments of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A foldable sunshade provided by this disclosure, characterized by comprising a shading board body and a fixed part, wherein two or more than two vertical folding lines which are distributed along the transverse direction of the shading board body and run through the vertical direction of the shading board body are arranged on the shading board body, and the shading board body is divided into a plurality of folding units by every two adjacent vertical folding lines and two transverse sides of the shading board body, or one vertical folding line, one vertical side of the shading board body and two transverse sides of the shading board body; transverse folding lines running through the transverse direction of each folding unit are further arranged at the center of each folding unit, the quantity of the transverse folding lines in each folding unit is two, and the two transverse folding lines in each folding unit are symmetrically distributed by taking the transverse center line of the shading board body as a symmetry axis; the shading board can be folded along the vertical folding lines and the transverse folding lines, and the folded shading board is fixed by using the fixed part.

2. The foldable sunshade according to claim 1, characterized in that the lengths of segments, intercepted by every two adjacent vertical folding lines, of straight lines parallel to the transverse center line of the shading board body are equal.

3. The foldable sunshade according to claim 1, characterized in that the folding directions of every two adjacent vertical folding lines are opposite.

4. The foldable sunshade according to claim 1, characterized in that, along the direction from the first end of the transverse direction of the shading board body to the second end of the transverse direction of the shading board body, in every two adjacent folding units, the distance between two transverse folding lines of the folding unit closer to the second end is greater than that between two transverse folding lines of the folding unit closer to the first end.

5. The foldable sunshade according to claim 4, characterized in that the distance between two transverse folding lines of the folding unit mostly close to the first end is greater than the thickness of the shading board body.

6. The foldable sunshade according to claim 5, characterized in that, along the direction from the first end to the second end, the distance between two transverse folding lines of the folding unit is increased in an arithmetic progression manner.

7. The foldable sunshade according to claim 6, characterized in that the tolerance of the arithmetic progression is the thickness of the shading board body.

8. The foldable sunshade according to claim 4, characterized in that the fixed part is a fastener, the fastener is detachably connected with the shading board body, the fastener comprises a fastener body, inserters connected with the upper edge of the fastener body and a snap closure connected with the upper surface of the fastener body, inserter holes and a snap closure hole corresponding to the inserters and the snap closure are formed in the shading board body, and the fastener is connected with the shading board body through the inserter holes and the snap closure hole.

9. The foldable sunshade according to claim 8, characterized in that the fastener is mounted at one end of the folding unit close to the second end, and the fastener is positioned on the outer surface of the folding body after the shading board body is completely folded.

10. The foldable sunshade according to claim 1, characterized in that the shading board body is in the shape of a rounded rectangle.
